(19) United States
(12) Patent Application Publication
(10) Pub. No.: US 2026/0219943 A1
(43) Pub. Date: Jul. 30, 2026

(54) SYSTEM AND METHOD FOR ENERGY-AWARE ORCHESTRATION OF DISTRIBUTED ARTIFICIAL INTELLIGENCE COMPUTE USING ENERGY TELEMETRY

(71) Applicant: Solyx AI, Inc, Biscayne Park, FL (US)

(72) Inventor: Aleksandr Bernhard, Biscayne Park, FL (US)

(73) Assignee: Solyx AI, Inc, Biscayne Park, FL (US)

(21) Appl. No.: 19/438,728

(22) Filed: Jan. 2, 2026

Related U.S. Application Data
(60) Provisional application No. 63/750,827, filed on Jan. 29, 2025.

(51) Int. Cl. G06F 9/50; G06F 1/28

(52) U.S. Cl. CPC G06F 9/5027; G06F 1/28

(57) ABSTRACT

Systems and methods are disclosed for energy-aware orchestration of distributed artificial intelligence compute workloads using energy telemetry. An orchestration layer assigns and updates AI workload execution across distributed compute nodes based on real-time and predictive energy-related data, including energy mix, pricing, carbon intensity, and energy storage availability. The system may adjust workload placement, execution timing, or resource utilization in response to changing energy conditions or grid-related signals while ensuring execution feasibility. The disclosed techniques enable improved alignment between compute execution and energy availability in distributed AI infrastructure environments.

### CROSS-REFERENCE TO RELATED APPLICATIONS

This application claims priority under 35 U.S.C. § 119(e) to U.S. Provisional Patent Application No. 63/750,827 filed on Jan. 29, 2025, entitled “System and Method for Orchestrating AI Compute Based on Smart Grid Integration with Real-Time Energy Mix Awareness”, the entire disclosure of which is incorporated herein by reference.

### STATEMENT REGARDING FEDERALLY SPONSORED RESEARCH OR DEVELOPMENT

Not applicable.

### FIELD OF THE INVENTION

The present invention relates generally to distributed computing systems, and more particularly to systems and methods for orchestrating artificial intelligence (AI) compute workloads across distributed infrastructure using real-time and predictive energy telemetry, including grid signals, energy mix data, and energy storage information.

### BACKGROUND OF THE INVENTION

### Distributed AI Compute Infrastructure

Modern artificial intelligence workloads, including inference, training, and agent-based execution, are increasingly deployed across geographically distributed compute infrastructure. Conventional orchestration systems typically allocate workloads based on abstract computing resource metrics such as processor availability, accelerator count, or memory capacity.

These systems generally operate independently of the physical energy systems supplying the compute infrastructure and often fail to account for real-time variability in energy availability, energy source composition, or grid operating conditions.

### Energy-Aware and Sustainability-Driven Scheduling

Some existing systems attempt to reduce operational cost or environmental impact by shifting workloads based on electricity pricing, renewable energy availability, or estimated carbon intensity. Such approaches are often limited to coarse temporal or geographic adjustments and may not incorporate real-time grid signals, predictive energy modeling, or direct interaction with energy storage systems.

Furthermore, existing approaches typically lack integrated mechanisms for coordinating AI workload execution with demand response programs, grid constraints, or energy storage availability.

### Limitations of Existing Systems

Existing orchestration systems commonly exhibit one or more of the following limitations: Energy conditions are treated as external constraints rather than primary control inputs, grid signals and demand response events are not integrated into workload orchestration, predictive modeling of energy availability is not incorporated into execution planning, energy storage systems are not coordinated with compute workload scheduling.

Accordingly, there exists a need for systems and methods that tightly integrate AI workload orchestration with energy telemetry, predictive energy modeling, and energy storage, enabling compute execution decisions to reflect real-world energy conditions.

### SUMMARY OF THE INVENTION

The present invention provides systems and methods for energy-aware orchestration of distributed artificial intelligence compute workloads using energy telemetry and predictive energy information.

In one embodiment, the system comprises:
an orchestration layer configured to assign AI compute workloads across a plurality of distributed compute nodes;
one or more energy telemetry interfaces configured to receive real-time and forecasted energy information associated with the compute infrastructure;
a predictive energy modeling component configured to generate forecasts of future energy conditions;
an energy storage interface configured to obtain information regarding availability of stored energy; and
a mechanism for updating workload execution decisions based on current and predicted energy conditions.

Energy information may include, without limitation, energy source composition, renewable generation output, electricity pricing, carbon intensity, grid demand response signals, and energy storage state.

In operation, the orchestration layer coordinates AI workload execution to preferentially utilize available low-carbon or low-cost energy resources while respecting compute performance requirements.

### DETAILED DESCRIPTION OF THE INVENTION

### System Architecture

The system includes a plurality of distributed compute nodes, which may be geographically dispersed and interconnected via one or more communication networks. Each compute node includes processing resources capable of executing AI workloads, including inference and training tasks.

An orchestration layer manages workload placement and execution across the distributed compute nodes. The orchestration layer may execute on one or more computing systems and maintains information regarding workload requirements, node capabilities, and energy conditions.

### Energy Telemetry and Energy Data

The system receives energy telemetry from one or more external sources, including utility systems, grid operators, energy markets, or on-site energy monitoring systems. Energy telemetry may include: real-time energy availability, energy source composition, including renewable and non-renewable sources, electricity pricing and market signals, carbon intensity indicators, grid demand response or load-shedding signals.

### Predictive Energy Modeling

In some embodiments, the system includes a predictive energy modeling component configured to generate forecasts of future energy conditions. Forecasts may be based on historical energy data, weather information, grid schedules, or other relevant inputs.

Predictive modeling may be implemented using statistical techniques, machine learning models, or other forecasting approaches.

### Energy Storage Coordination

In some embodiments, the system obtains information regarding the availability of energy storage resources, including battery energy storage systems. The orchestration layer may schedule AI workloads to utilize stored energy during periods of limited renewable generation or elevated grid demand.

### Workload Orchestration and Updating

The orchestration layer assigns AI workloads to compute nodes based on a combination of compute requirements and energy conditions. Workload execution decisions may be updated over time as new telemetry or forecasts become available.

Updates may occur periodically or in response to detected changes in energy conditions, forming a feedback-based orchestration process. In assigning workloads, the orchestration layer may additionally ensure that sufficient compute capacity and required execution resources are available at a candidate compute node, such capacity considerations acting as feasibility constraints in conjunction with energy-aware scheduling decisions.

### Demand Response and Grid Interaction

In some embodiments, the system participates in demand response programs or responds to grid-initiated signals by adjusting AI workload execution, deferring non-critical tasks, or shifting execution to alternative compute nodes.

What is claimed is:

1. A system for orchestrating artificial intelligence compute workloads, comprising:
an orchestration layer configured to assign AI workloads across a plurality of distributed compute nodes;
one or more energy telemetry interfaces configured to receive energy-related data associated with the distributed compute nodes;
wherein the orchestration layer assigns or updates workload execution decisions based at least in part on the received energy-related data.

2. The system of claim 1, wherein the energy-related data includes information indicating an energy source composition associated with at least one compute node.

3. The system of claim 2, wherein the energy source composition includes a proportion of renewable versus non-renewable power.

4. The system of claim 1, wherein the energy-related data includes carbon intensity data received from grid operators.

5. The system of claim 1, wherein the energy-related data includes real-time energy pricing.

6. The system of claim 1, wherein the energy-related data includes forecasted energy availability.

7. The system of claim 6, wherein the orchestration layer utilizes forecasted energy availability generated by a predictive energy modeling process to schedule AI workloads proactively.

8. The system of claim 7, wherein the predictive energy modeling process utilizes machine learning algorithms to anticipate future energy conditions.

9. The system of claim 1, further comprising an interface to an energy storage system, wherein workload execution decisions are based in part on availability of stored energy.

10. The system of claim 9, wherein the orchestration layer prioritizes AI workloads when stored energy exceeds a threshold availability level.

11. The system of claim 1, wherein the orchestration layer modifies workload execution in response to demand response signals by at least one of: deferring workload execution, shifting workloads to alternative compute nodes, adjusting workload priority, or reducing workload intensity.

12. The system of claim 11, wherein the demand response signals include grid-initiated load reduction requests.

13. The system of claim 1, wherein at least one of the distributed compute nodes includes co-located renewable generation.

14. The system of claim 13, wherein the orchestration layer prioritizes workload assignment to compute nodes when locally generated renewable energy is available.

15. A method for orchestrating artificial intelligence compute workloads, comprising:
receiving energy-related data associated with distributed compute nodes;
assigning AI workloads to the distributed compute nodes based at least in part on the energy-related data; and
updating workload execution decisions as energy-related data changes.

16. The method of claim 15, wherein the energy-related data includes at least one of: energy source composition, electricity pricing, or carbon intensity.

17. The method of claim 15, wherein the energy-related data includes forecasted energy availability.

18. The method of claim 17, further comprising scheduling compute workloads proactively based on anticipated future energy conditions.

19. The method of claim 15, wherein assigning AI workloads comprises prioritizing locally available renewable energy.

20. The method of claim 15, wherein updating workload execution decisions comprises shifting AI compute loads to periods of high renewable generation or low grid demand.

21. The method of claim 15, wherein assigning AI workloads comprises reducing reliance on carbon-intensive power.

22. The method of claim 15, further comprising modifying workload execution in response to demand response signals by at least one of: deferring workload execution, shifting workloads to alternative compute nodes, or reducing workload intensity.

23. The method of claim 15, further comprising scheduling AI workloads to utilize stored energy during periods of limited renewable generation.
